(19) United States
(12) Patent Application Publication
(10) Pub. No.: US 2025/0156288 A1
(43) Pub. Date: May 15, 2025

(54) PROTOCOL TESTING USING LARGE LANGUAGE MODELS

(71) Applicant: Microsoft Technology Licensing, LLC, Redmond, WA (US)

(72) Inventors: Siva Kesava Reddy KAKARLA, Redmond, WA (US); Ryan Andrew BECKETT, Redmond, WA (US)

(21) Appl. No.: 18/440,713

(22) Filed: Feb. 13, 2024

Related U.S. Application Data
(60) Provisional application No. 63/599,362, filed on Nov. 15, 2023.

(51) Int. Cl. G06F 11/28

(52) U.S. Cl. CPC G06F 11/28

(57) ABSTRACT

The present disclosure relates to utilizing resources provided by large language models (LLMs) to generate models to be used in model-based testing of a variety of protocols. In particular, systems described herein utilize a vasty body of protocol knowledge defined in RFCs and standards, networking forums, blogs, and other online resources and documents to extract this knowledge in generating models that can be used for testing one or more components of a variety of protocols. The features and functionalities described herein provide a framework for utilizing LLMs to generate a protocol model while providing constraints for a harness (e.g., a symbolic harness) that will guide a symbolic execution engine in generating any number of protocol tests that may be used in determining whether a given application, hardware, and/or software implementation will perform as designed for a given protocol.

### CROSS REFERENCE TO RELATED APPLICATIONS

This application claims priority to U.S. Provisional Application No. 63/599,362, filed on Nov. 15, 2023, the entirety of which is incorporated herein by reference.

### BACKGROUND

Recent years have seen significant increase in popularity and applications of artificial intelligence (AI) and machine learning (ML). In addition, with services hosted by cloud computing systems becoming increasingly available to end-users and other organizations, accessibility to more complex and robust computing models, such as large language models (LLMs) has become increasingly common. These foundation models can be trained to perform a wide variety of tasks, such as chat bots, providing answers to general questions, generating code and other programming script, and, in some cases, writing executable code for a variety of applications. While foundation models, such as ChatGPT and other large language models (LLMs) provide useful tools in performing a variety of tasks using a significant pool of computing resources and massive corpus of knowledge, there are many technical difficulties that arise from using LLMs (and other foundation models) to perform a variety of tasks.

### BRIEF DESCRIPTION OF THE DRAWINGS

FIG. 1 illustrates an example environment including a protocol test generation system in accordance with one or more embodiments.

FIG. 2 illustrates an example implementation of a protocol test generation system in accordance with one or more embodiments.

FIG. 3 illustrates an example workflow in which a protocol test generation system generates protocol tests in accordance with one or more embodiments.

FIG. 4 illustrates an example of a library that may be used in generating protocol tests in accordance with one or more embodiments.

FIG. 5A illustrates an example model description prompt in accordance with one or more embodiments.

FIG. 5B illustrates an example model generation prompt in accordance with one or more embodiments.

FIG. 6 illustrates an example protocol model in accordance with one or more embodiments.

FIG. 7 illustrates an example workflow involving a protocol test generation system generating protocol tests in accordance with one or more embodiments.

FIG. 8 illustrates an example series of acts for generating protocol tests as described herein, in accordance with one or more embodiments.

FIG. 9 illustrates certain components that may be included within a computer system.

### DETAILED DESCRIPTION

The present disclosure relates to systems, methods, and computer-readable media for utilizing resources provided by large language models (LLMs) to generate models to be used in model-based testing of a variety of protocols. In particular, systems described herein utilize a vasty body of protocol knowledge defined in requests for common documents (RFCs) and standards, networking forums, blogs, and other online resources and documents to extract this knowledge in generating models that can be used for testing one or more components of a variety of protocols. The features and functionalities described herein provide a framework for utilizing LLMs to generate a model while providing parameters and a harness (e.g., a symbolic harness) that will guide a symbolic execution engine in generating any number of tests that may be used in determining whether a given application, hardware, and/or software implementation will perform as designed when operating according to a given protocol.

By way of example, and as will be discussed in further detail herein, the present disclosure describes a protocol test generation system that facilitates generation of a model generation prompt including a description of a protocol and instructions associated with generating a protocol model to be provided as an input to an LLM. The protocol test generation system may obtain a protocol model (e.g., a modeled component, feature, or function of the protocol) including executable code generated by the LLM based on the model generation prompt. The protocol test generation system may further facilitate generation of a symbolic harness in accordance with the model generation prompt and one or more validity constraints to guide generation of a plurality of protocol tests. The protocol test generation system may cause a symbolic execution engine to be applied to the modeled protocol based on the symbolic harness to generate the plurality of protocol tests. The protocol tests can be performed by any of a number of applications, software, and/or hardware implementations (or simply “protocol implementations”) to determine which of the particular implementations will execute the protocol tests as designed. This may facilitate finding bugs in the protocol implementations related to coding errors, misinterpretations of RFCs, unsound optimizations, unforeseen corner cases, poor data structure choices, etc.

The present disclosure provides a number of practical applications that provide benefits and/or solve problems associated with generating protocol models as well as generating tests to determine whether certain implementations will perform as designed in connection with a corresponding protocol or protocol component. By way of example and not limitation, some of these features and corresponding benefits will be discussed in connection with example problems and shortcomings of conventional protocol testing and, more specifically, model-based testing (MBT) approaches.

For example, by utilizing LLMs, implementations of the protocol test generation system described herein provide a technique in which protocol models may be generated using computing resources while realizing the benefits of MBT approaches. Indeed, because MBT is effective at testing protocols, it can be implemented to find bugs in implementations involving a variety of protocols (e.g., QUIC, DNS, BGP), particularly when used as an alternative to manual testing or automatic testing using fuzzing. However, while MBT avoids many problems of conventional manual and/or automatic testing approaches, MBT still requires substantial effort from users to arduously build models of the protocol to be tested.

While using LLMs provides a mechanism to overcome some of the challenges of user-driven MBT approaches, implementing LLMs in this way presents a number of unique problems that features and functionalities of the protocol test generation system can effectively overcome. For example, in one or more embodiments, the protocol test generation system utilizes a symbolic execution engine to generate protocol test cases for any number of paths of a given model. By generating a prompt and providing this prompt to the symbolic execution engine, systems described herein facilitate an exhausting plurality of protocol tests (e.g., protocol component tests) in which a large number (or all) possible paths of a model are explored, which is not generally provided by an LLM without the assistance of the symbolic execution engine. This may facilitate testing uncommon and/or corner cases of a protocol implementation that conventional methods often fail to identify.

In addition to providing an exhaustive testing approach, features of the protocol test generation system overcome problems involved with LLMs in generating tests that rely on valid inputs. For example, by providing valid constraints and further relying on a constraint solver provided by a symbolic execution engine, the protocol test generation system avoids some common problems when using LLMs, such as generating any number of invalid tests based on a non-targeted output of the LLM in the resulting protocol model.

Further, while one or more approaches involve generating tests that attempt to cover the entirety of a protocol, due to the complex nature of many protocols, this can be an impractical or unrealistic approach to testing protocol models. Instead, features and functionality of the protocol test generation system involve generating a model associated with one or more targeted components of a given protocol, such as a specific or targeted subset of protocol functionality. This reduces the complexity of generating tests for a given model, but also provides a more focused approach to testing a protocol in a way that enables an individual or system to determine which portion or subset of functionalities of a given protocol are problematic for a particular implementation (e.g., software and/or hardware implementation).

As illustrated in the foregoing discussion, the present disclosure utilizes a variety of terms to described features and advantages of one or more embodiments of the protocol test generation system. Additional detail will now be provided regarding the meaning of some of these terms. Further terms will also be discussed in detail in connection with one or more embodiments and specific examples below.

As used herein, a large language model (LLM) refers to an AI or ML model that is trained to generate an output in response to an input based on a large dataset. In one or more embodiments described herein, an LLM may refer more generally to a foundation model. An LLM may include a neural network having a significant number of parameters (e.g., billions of parameters) that the LLM can consider in performing a task or otherwise generating an output based on an input. In one or more embodiments, an LLM is trained to generate a response to a query or prompt. The LLM may receive any number of parameters to guide the LLM in generating a model (e.g., a protocol testing model) configured to receive a particular type of input and generate a particular type of output. Indeed, an LLM may be trained to generate any of a variety of outputs based on any of a variety of input prompts. In one or more embodiments, an LLM is a version or generation of GPT (e.g., GPT 3.5, GPT 4.0) or other brand or variation of an LLM that accepts and processes natural language queries (or other types of input queries). Indeed, while one or more embodiments described herein refer to features associated with determining context for an LLM, similar features may apply to generating context and determining outputs using other types of foundation models.

As used herein, a “protocol” refers to a set of rules, behaviors, and/or policies associated with communicating data between devices or components (e.g., hardware and/or software components). Protocols can range in complexity and may apply to any number of applications and/or hardware layers within a computing and/or networking environment. Examples of one or more protocols referred to herein include Quick UDP Internet Connections (QUIC) protocol, Domain Name System (DNS) protocol, and Border Gateway Patrol (BGP) protocol. Nevertheless, features described herein in connection with generating and implementing models and protocol tests may apply to any number of protocols. Indeed, while one or more examples described herein are provided in connection with a DNS protocol, features described in connection with generating models and protocol tests in connection with a DNS protocol may similarly apply to other types of protocols.

As used herein, a “protocol model” may refer to a code or portion of code generated by an LLM that represents or models a particular protocol behavior. This may be in contrast to the particular source code of the protocol which carries out or is otherwise associated with that behavior. In one or more embodiments, a protocol model refers to a specific subset, function, or component of a protocol and includes executable code that models this portion of behavior within a protocol. One or more examples described herein refer specifically to a component (e.g., a function or set of functions) of a DNS protocol. Other examples may include different subsets of DNS protocol behavior. Indeed, a protocol model may refer to a component or subset of behavior associated with any of a variety of protocols.

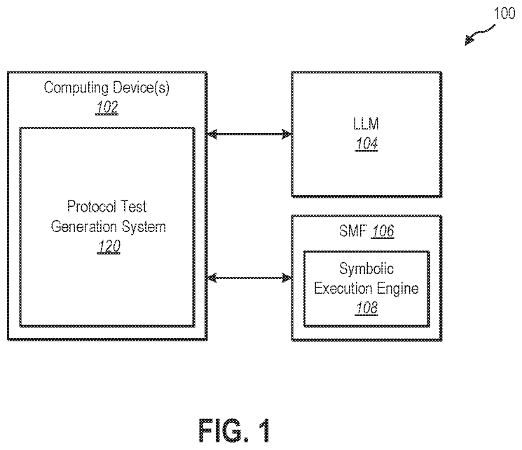

Additional detail will now be provided regarding a protocol test generation system in accordance with one or more example implementations and in connection with some example illustrations. For example, FIG. 1 illustrates a block diagram showing an environment 100 in which components of a protocol test generation system 120 are implemented on one or more computing device(s) 102. The environment 100 includes an additional computing device(s) 106. The computing device(s) 106 includes a symbolic execution engine 108 implemented thereon. In some embodiments, the symbolic execution engine 108 is implemented on the same computing device as the protocol test generation system 120. As further shown, the environment 100 includes a large language model (LLM) 104 in communication with the computing device(s) 102 for processing model generation prompts and generating protocol model(s) responsive to model generation prompts.

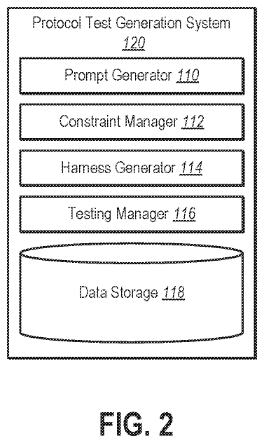

FIG. 2 illustrates an example implementation of the protocol test generation system 120 as described herein, according to at least one embodiment of the present disclosure. The protocol test generation system 120 may include a prompt generator 110, a constraint manager 112, a harness generator 114, and a testing manager 116. The protocol test generation system 120 may also include a data storage 118 having various data stored thereon. While one or more embodiments described herein include features and functionalities performed by specific components 110-116 of the protocol test generation system 120, it will be appreciated that specific features described in connection with one component of the protocol test generation system 120 may, in some examples, be performed by one or more of the other components of the protocol test generation system 120.

By way of example, generation of one or more prompts by the prompt generator 110 may be delegated to other components of the protocol test generation system 120. As another example, while a constraint manager may facilitate implementing one or more generating test for a protocol, in some instances, some or all of these features may be performed by the prompt generator 110 (or other component of the protocol test generation system 120). Indeed, it will be appreciated that some or all of the specific components may be combined into other components and specific functions may be performed by one or across multiple components 110-116 of the protocol test generation system 120.

As mentioned above, the protocol test generation system 120 includes a prompt generator 110. The prompt generator 110 may facilitate generating a model generation prompt for providing to the LLM 104. For example, the model generation prompt may include a variety of information for proving as input to the LLM including types of test parameters, definitions of functions, arguments, inputs, outputs, etc.

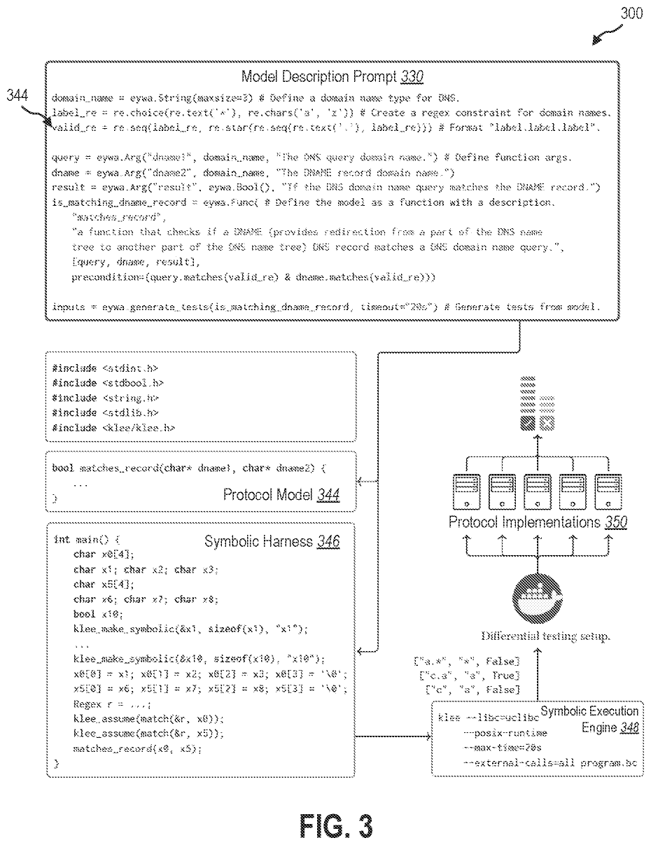

In some embodiments, the prompt generator 110 generates the model generation prompt based on a receiving a model description prompt. For example, the prompt generator 110 may receive a model description prompt based on user input. FIG. 3 illustrates a workflow 300 for the protocol test generation system 120, according to at least one embodiment of the present disclosure. The workflow 300 includes an example model description prompt 330. In some embodiments, the model description prompt 330 may be implemented in python code, or any other suitable programming language.

The model description prompt may provide a high-level description of a protocol to facilitate the LLM 104 generating a model of the protocol. For example, the model description prompt may define the protocol (e.g., may define the model to be generated by the LLM 104) with its arguments, results, and/or any validity constraints. For example, the model description prompt may identify the relevant input and output types for the protocol. From these inputs, the LLM 104 may generate a model of the protocol as described herein. In some embodiments, the model description prompt may indicate a component, part, or subset of a protocol to test. In this way, the model description prompt may indicate a granularity or scope of the resulting protocol tests. This may facilitate scoping the test to what the LLM 104 can reasonably handle in order to facilitate modular testing.

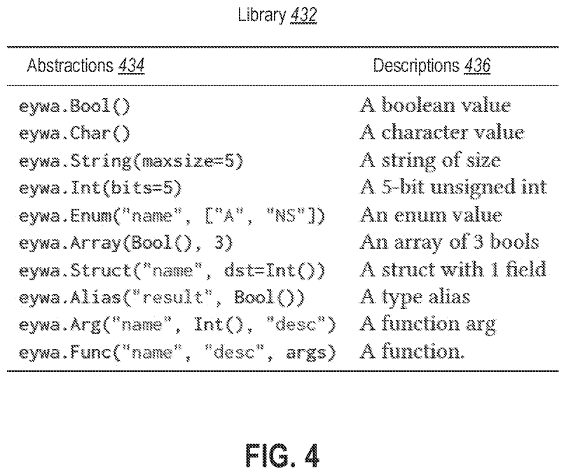

In some embodiments, the model description prompt may be implemented in conjunction with a library. FIG. 4 illustrates an example of a library 432. The library 432 may facilitate building models as typed functions that accept a set of arguments and return a result. The library 432 may include library abstractions 434 that may be utilized as objects in the model description prompt for describing the protocol (or component of the protocol) to be tested. For example, the model description prompt may implement protocol-specific objects (e.g., state) and formats (e.g., headers, inputs, etc.). The model description prompt may implement functions over these objects. The model description prompt may indicate functions with a name, a natural language description of the function's purpose, and a list of arguments. Each argument may also have a name and description as well as an associated type.

In some embodiments, the library enables the creation of function arguments with standard types. For example, the library may include operator and character types such as booleans, characters, strings, fixed bit width integers, enums, arrays, structs, etc. The library may facilitate creating type aliases that allow for associating custom names with types. The type aliases may facilitate the LLM 104 understand a value's meaning. In some embodiments, the model description prompt may indicate a bound or size of a type that may potentially be unbounded (e.g., eywa.String( )). This may limit the size and number of test cases that the protocol test generation system 120 produces. In this way, the model description prompt may be generated based on implementing objects from the library.

Turning back to the workflow 300 of FIG. 3, the example model description prompt 330 identifies an example model defined via the library abstractions to test the “DNAME” record type feature used in DNS to redirect queries across domains. For example, the first line of the model description prompt 330 defines a DNS domain name type (domain_name) as a string, and limits the size of the string to 3 characters to bound the number of testes. The code defines the model as a function “is_matching_dname_record” that tests whether a DNS query's domain name matches that of a DNAME record's domain name. The three definitions (query, dname, result) give the function arguments and return values respectively and include natural language descriptions of their meaning. The model description prompt may also provide a description of the function's purpose as well as any constraint on the argument (precondition), as described herein. For example, the last line of the model description prompt 330, “eywa.generate_tests,” takes a function (model) as well as a timeout (20 seconds) and returns a set of protocol test cases for the model in the form of a list of values for each function argument (e.g., [“a.*”, “*”, False], where “a.*” is the query domain name, “*” is the DNAME record domain name, and False is the return value).

As mentioned above, the protocol test generation system 120 includes a constraint manager 112. The constraint manager 112 may facilitate implementing and/or encoding one or more constraints in the model description prompt. For example, in some embodiments, the LLM 104 may generate a model that can result in test cases that are either invalid or otherwise are not useful. One or more constraints may be implemented over a function argument in order to limit the test cases generated. For example, a constraint may indicate an enforceable format of a string or a threshold value of a protocol field. Any number of constraints and/or types of constraints may be implemented, such as arithmetic, (in)equality and comparison constraints for integers, regular expression constrains for strings, or any other constrains. In some embodiments, constraint descriptions may be included in the model description prompt. Indeed, the constrains may refer to any rule or limitation placed on a resulting protocol model to be enforced by the symbolic execution engine 108 in generating test cases based on the LLM-generated protocol model(s).

As an illustrative example, in the example workflow 300 of FIG. 3, in the associated protocol, domain names may only be valid that are in the format of populated labels separated by dots or periods. Accordingly, a domain name including empty labels may not be valid. Without instructing the symbolic execution engine 108 to check for valid domain names, the symbolic execution engine 108 may find unhelpful test cases (e.g., [“a..”, “..”, True]). As shown, a constraint 344 may be encoded in the model description prompt 330 that instructs the symbolic execution engine 108 to solve for inputs that satisfy the validity requirements for domain names of the protocol (e.g., only dot-separated sequences of string labels, where each label is either alphanumeric or a special character “*”).

In some embodiments, the constrains may instruct the symbolic execution engine 108 to enforce the constraints, for example, instead of the LLM 104. For example, instructing the LLM 104 to additionally check for validity constraints may add unnecessary complexity to the task the LLM 104 performs. In contrast, including the constrains in the model description prompt 330 (and additionally constructing the symbolic test harness as described herein to include the constraints) may instruct the symbolic execution engine 108 to only consider the subset of test cases that satisfy the constraints, thereby simplifying the operation of the symbolic execution engine 108 and/or the LLM 104.

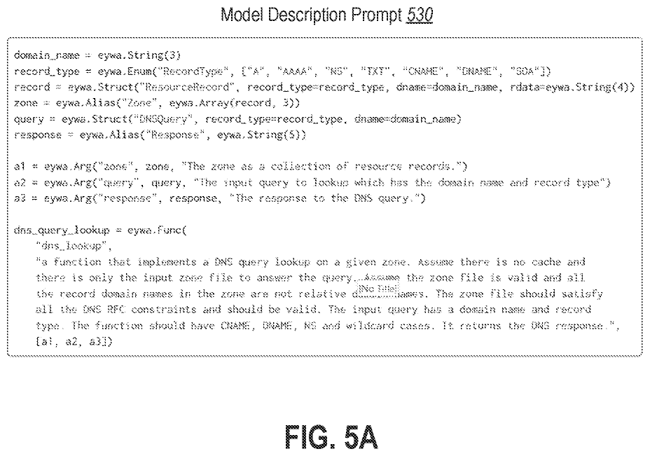

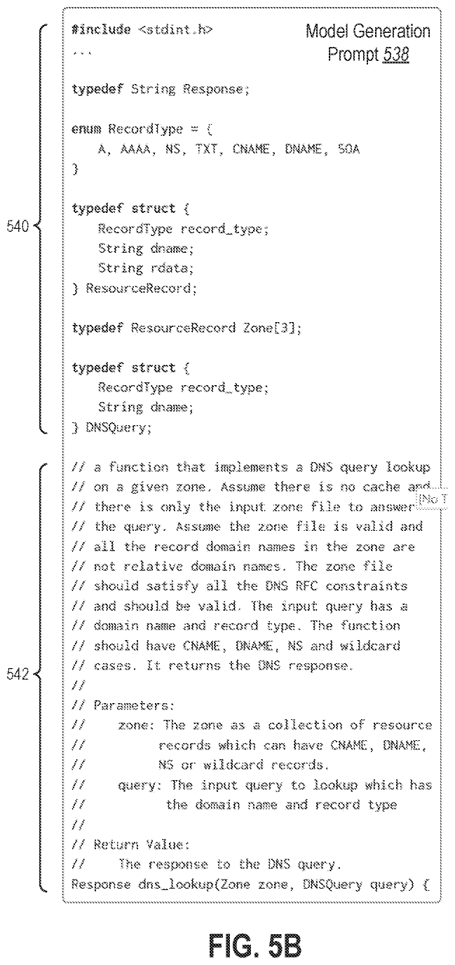

In some embodiments, the prompt generator 110 generates a model generation prompt. The model generation prompt may be based on the information provided via the model description prompt (e.g., user input) and may be in a format suitable for input to the LLM 104. For example, given the model description prompt, the prompt generator 110 may build a model generation prompt that will lead the LLM 104 to generate a model of the specific functionalities and/or components of the protocol to be tested. FIG. 5A illustrates an example model description prompt 530 and FIG. 5B illustrates an example model generation prompt 538 generated by the prompt generator 110 based on the model description prompt 530.

In some embodiments, the prompt generator 110 generates or implements the model generation prompt as two prompts. For example, the model generation prompt 538 may include a completion prompt 540 and a system prompt 542. The completion prompt may frame the implementation tasks as a completion problem. For example, the prompt generator 110 may translate each of the (e.g., user-defined) model types into a specific data structure for the LLM 104 (e.g., C data structure or any other data structure compatible with the LLM 104 and/or compatible with the symbolic execution engine 108 as described herein). The prompt generator 110 may translate the function signature into this data structure using the definitions from the library. The prompt generator 110 may add a function documentation string based on the descriptions of the function as well as each of the parameters. From this prompt, the LLM 104 may predict or complete the rest of the function. For example, the LLM 104 may rely on its knowledge of the protocol (e.g., from RFCs, online resources, etc.) to augment or supplement the information from the model description prompt to provide complete and/or compliant statements for the data structure. In this way, the completion prompt may identify definitions of the (user-defined) model types as executable code (e.g., C code) for the LLM 104 to assume.

In the example in FIG. 5B, the model generation prompt 538 implements the main DNS query lookup functionality that takes a user Zone (collection of resource records) and a DNS query, and generates a DNS response. In some embodiments, the prompt generator 110 may generate on or more new data types to facilitate with the implementation. For example, the completion prompt 540 indicates a DNS record type, record zone type, query type, and response data type. In this way, the prompt generator 110 may generate a model generation prompt including a completion prompt that translates the types of the functions as well as provides function documentation to assist the LLM 104 in generating the protocol model.

In some embodiments, the model generation prompt includes a system prompt. The example model generation prompt 538 of FIG. 5B shows an example of a system prompt 542. The system prompt may guide the behavior of the LLM 104. In some embodiments, the system prompt provides additional guidance to help ensure that the LLM 104 generates valid code. For example, the system prompt may describe the task to implement the function provided by the completion prompt. The system prompt may indicate for the LLM 104 to add import statements. The system prompt may indicate for the LLM 104 to remove existing imports. The system prompt may indicate for the LLM 104 to not delete or modify one or more of the type definitions. The system prompt may indicate for the LLM 104 to implement the function(s) as provided, for example, and not implement its own main( ) function. The system prompt may indicate for the LLM 104 not to use certain functions that are not compatible with the symbolic execution engine 108. The system prompt may indicate an example of a valid input and/or output. In some embodiments, some or all of the system prompt may be implemented as plain language. For example, as shown in FIG. 5B, the system prompt 542 is provided as plain language and/or in comment notation within the model generation prompt 538. In this way, the prompt generator 110 may generate a system prompt to facilitate the LLM 104 generating a valid model that may be compliant for implementation by the symbolic execution engine 108.

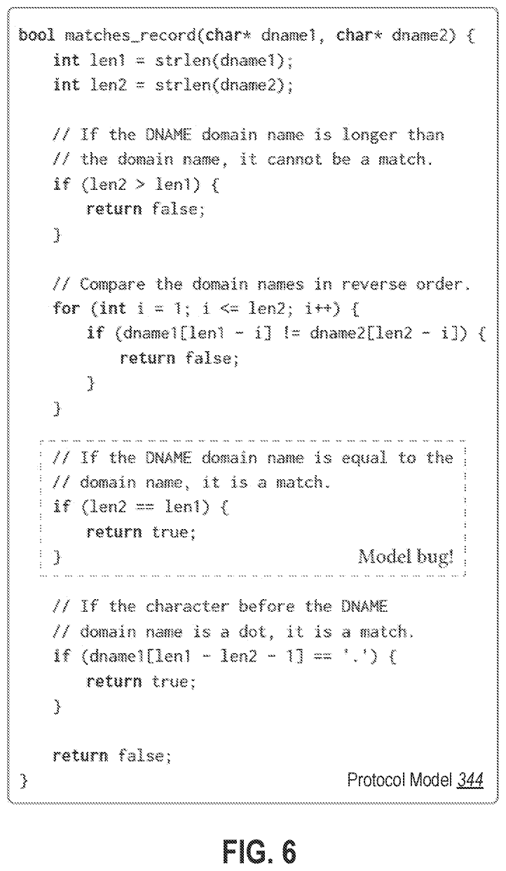

The protocol test generation system 120 (e.g., the prompt generator 110) may provide the model generation prompt to the LLM 104 in order that the LLM 104 may generate a protocol model. For example, based on the model generation prompt, the LLM 104 may build a reference protocol implementation (e.g., protocol model) by generating executable code (e.g., C code). The example workflow 300 of FIG. 3 shows a protocol model 344 generated based on the model description prompt 330. As described herein, the model description prompt 330 may form the basis of a model generation prompt provided to the LLM 104 in order to generate the protocol model 344. The example workflow 300 shows a condensed or simplified example of the protocol model 344, and FIG. 6 illustrates a more complete example of the protocol model 344 of FIG. 3.

The protocol model may represent the specific components, functions, etc. of the protocol to be tested, for example, based on the input and output types, definitions, descriptions, etc. defined in the library abstractions. In this way, the protocol model may facilitate testing the behavior or functionality of a specific protocol component (or the protocol generally) by testing these attributes in the protocol model, for example, rather than tasking a specific component (e.g., the LLM 104) with testing the protocol directly. Further, the protocol model may be generate based only on high-level description of the protocol component (e.g., provided by a user) in connection with additional information provided by the library abstractions such as input and output types.

The LLM 104 may construct the protocol model based on its knowledge and understanding of the protocol that it will be modeling. For example, for many protocols (e.g., DNS, BGP, ICMP, etc.) the LLM 104 may have a sufficient understanding of the protocol based on the substantial amount of knowledge widely available for the protocol (e.g., via the internet). The LLM 104 may construct the protocol model to model characteristics of the protocol component based on the LLM's 104 understanding of the protocol. For protocols where less information is available and/or where the LLM 104 may only have a basic understanding of the protocol, the knowledge of the LLM 104 may be augmented with protocol-specific documents and specifications (e.g., by user input). For example, this additional information may be included in the model description prompt and/or model generation prompt to fine tune the LLM 104 with respect to the protocol.

As mentioned above, the protocol test generation system 120 includes a harness generator 114. The harness generator 114 may generate a symbolic harness for use by the symbolic execution engine 108 in generating the test cases. As used herein, the symbolic harness may refer to a data object that initializes each of one or more symbolic function parameters by constructing symbolic value(s) of appropriate types (e.g., based on the identified inputs for the functions of the protocol model). The symbolic harness may translate the function preconditions or constraints into assumptions to be used by the symbolic execution engine 108 that are added as path constraints to the symbolic execution engine 108. The symbolic harness can call the protocol model produced by the LLM 104.

The example workflow 300 of FIG. 3 illustrates an example symbolic harness 346. The harness generator 114 (e.g., the symbolic compiler) may use a command (e.g., ‘make_symbolic’) to build symbolic inputs for one or more base types (e.g., bool, char, int, enum, etc.) and may construct more complex types from these base types. The protocol test generation system 120 (e.g., the harness generator 114) can construct arrays by declaring a new array of a corresponding size and can create each symbolic element and assign each element to the array. The harness generator 114 can initialize structures by creating a symbolic value for each field and assigning the fields to a new structure. Nested symbolic types like arrays of structures may be constructed recursively.

In some embodiments, one or more constraints may be implemented in generating a symbolic harness. For example, the harness generator 114 may include enforcement constraints within the symbolic harness. For example, to enforce user constraints, the harness generator may translate received constraints into coded (e.g., C code) constraints. This translation may be straight-forward (e.g., a constraint on two arguments such as:

(p1>3)& p2.matches(re.chars(“a”,“z”))

may become:

Regex r;r.lo=‘a’;r.hi=‘z’;

klee_assume((a1>3)& match(&r,&a2)).

The harness generator 114 may construct a regular expression (e.g., in C-code) that calls a custom function (e.g., match function) to check if a string matches a regular expression. The function may be a minimal regular expression matching implementation that has been written by hand and that is amenable to symbolic execution. Regular expression constraints are general and users may use them to enforce various conditions such as the length of a string, any string prefix or suffix constraint, and other constraints. The various conditions may be encoded by the symbolic execution engine 108. In this way, the harness generator 114 may generate a symbolic harness including a set of symbolic inputs and an initial state needed to start the symbolic execution of the protocol model by the symbolic execution engine 108.

As shown in FIG. 1, a second computing device 106 may include a symbolic execution engine 108 implemented thereon. The symbolic execution engine 108 may be implemented on a different device or system as shown in FIG. 1. Alternatively, in one or more embodiments, the symbolic execution engine 108 may be implemented as a component within the protocol test generation system 120 and implemented on the same device(s) or a common system of device(s) (e.g., a same cloud computing system). As will be discussed below, the symbolic execution engine 108 may include both an execution engine (e.g., KLEE) and a test translator. The workflow 300 shows an example implementation of a symbolic execution engine 348.

The symbolic execution engine 108 may run simulations on the protocol model based on information (e.g., symbolic values or symbolic inputs) contained in the symbolic harness. The symbolic execution engine 108 may run the execution engine and generate a set of protocol tests for testing the functionalities indicated in the model description prompt and/or model generation prompt. For example, the protocol test generation system 120 may take the protocol model and the symbolic harness and may combine then with an appropriate preamble for providing to the symbolic execution engine 108. The symbolic execution engine 108 may invoke a compiler (e.g., C compiler) and appropriate commands (e.g., KLEE commands) to instrument the code for symbolic execution, such as generating LLVM bytecode. The symbolic execution engine 108 may then run symbolic execution on the resulting LLVM bytecode in order to extract protocol test cases for testing the component functionality of the protocol. In some embodiments, the symbolic execution engine 108 may execute on the result with the user-provided timeout (if provided). For isolation, both tasks may be executed in a separate docker container and any errors, including compiler errors, may be reported back to the user as feedback. Users may use this feedback to update models of descriptions to the LLM.

In one example, based on each base symbolic value (e.g., symbolic C-variables), the symbolic execution engine 108 may identify one or more coded values (e.g., a C-value) for testing a particular aspect or function of the protocol. For instance, the symbolic execution engine 108 may perform symbolic execution on the protocol model in order to enumerate all values for symbolic inputs to the protocol model that results in a different execution path, or set of evaluations of conditional branches in the code. In some embodiments, the symbolic execution engine 108 provides results as a set of test inputs or test cases that assign each base symbolic variable (e.g., C variable) to a specific value (e.g., C value).

In one or more embodiments, the symbolic execution engine 108 runs the execution engine (e.g., KLEE) and the test translator translates the results (e.g., into Python values) for use by the testing manager. For example, the test translator may serialize these values, based on a library provided as input to the LLM 104, back to value types associated with the protocol. For example, the test translator may walk over the coded values (e.g., C-values) and may reconstruct any richer types (e.g., structure, array) from these coded values in order to translate the coded values back to a value type of the protocol (e.g., Python type). The resulting value type may correspond to the declared type. For example, for an array, the test translator may return a Python list. In another example, for a structure, the test translator may return a Python map from each field name to a corresponding value. The protocol test generation system 120 may also capture the output value of the protocol model and returns a list of values (e.g., one for each argument (and output) that the user provided).

As further shown in FIG. 1, the protocol test generation system 120 includes a testing manager 116. The testing manager 116 may receive the test cases generated by the symbolic execution engine 108 and may facilitate execute any number of the test cases in order to test the protocol (or component of the protocol). In one or more embodiments, the testing manager 116 is applied after generating the test cases as part of a differential testing process.

As shown in the example workflow 300 of FIG. 3, after receiving a plurality of test cases, the testing manager 116 may run the tests on a plurality of protocol implementations 350 (e.g., open-source platforms). The testing manager 116 may compare the results to see if they are consistent or not. If the tests are consistent, the testing manager 116 may presume that the protocol (or protocol component) is sound and will work as intended. However, if one or more of the protocol implementations 350 generate inconsistent results, the testing manager 116 may determine that the specific implementations will have protocol specific errors (e.g., bugs) in connection with the protocol component that was represented in the protocol tests that were generated. For example, for a DNS protocol, differential testing may be implemented to craft DNS zone files and queries from the test inputs to compare each DNS nameserver's response to find bugs. In this way, the protocol test cases generated by the symbolic execution engine 348 may be implemented in actual protocol implementation in order to identify protocol specific errors.

In this way, the protocol test generation system may provide a symbolic harness and a protocol model to a symbolic execution engine for initiating a differential testing setup and generating any number of tests across a variety of implementations (e.g., software and/or hardware implementations). Each of these tests may be provided to a user or system to implement the protocol testing for each of the different implementations. As noted above, the protocol test generation system may compare the results of the tests to determine which of the implementations are consistent and which implementations are generating inconsistent results and are therefore experiencing problems with the protocol component(s).

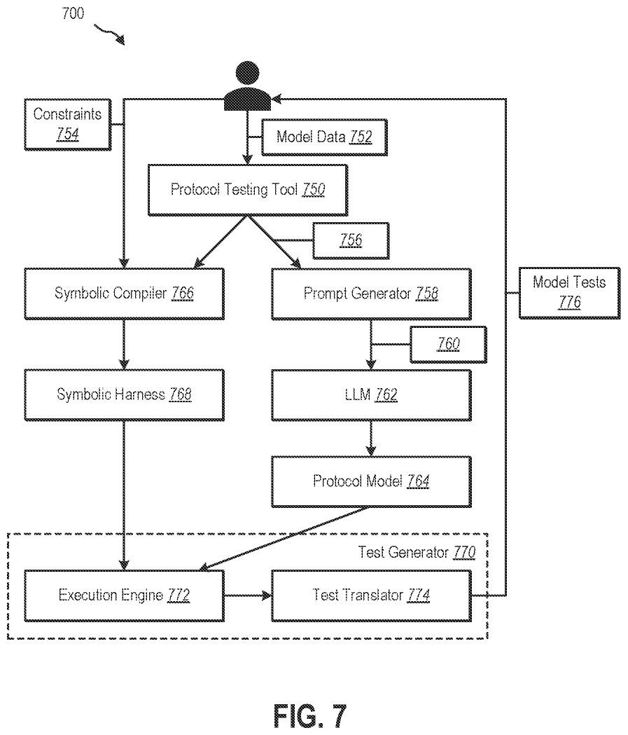

Turning now to FIG. 7, this figure provides an example workflow 700 showing interactions of an example implementation of the protocol test generation system 120 discussed above in connection with various illustrative figures. In particular, FIG. 7 illustrates an example workflow 700 showing components of a protocol testing tool 750 having components that perform similar features and functionality as the components of the protocol test generation system discussed above.

In particular, as shown in FIG. 7, the protocol testing tool 750 receives model data 752 from a user and/or constraints 754 associated with implementation of a resulting model. The protocol testing tool 750 provides a model description prompt 756 to the prompt generator 758 to generate a model generation prompt 760 to provide as input to the LLM 762. The LLM 762 processes the model generation prompt 760 to generate a protocol model 764. As noted above, the protocol model 764 may refer to a modeled component of the protocol or a subset of protocol functionality. The model generation prompt 760 may include a completion prompt that frames an implementation task as a completion problem. The model generation prompt 760 may further include a system prompt that guides behavior of the LLM 762.

In a parallel process as the generation of the protocol model 764, the protocol testing tool may provide model data 752 and constraints 754 to a symbolic compiler 766, which may generate a symbol harness 768 as discussed above. This may be in parallel. As shown in FIG. 7, the symbolic harness 786 and the protocol model 764 may be provided to a test generator 770 (e.g., the symbolic execution engine as discussed above). The test generator 770 may run an execution engine 772 (e.g., KLEE) and return a set of model tests 776 for use by a user in verifying correct functionality for a given protocol by various software and/or hardware implementations. In some embodiments, the test generator 770 may translate the model tests 776 with a test translator 774 from a format or language of the test generator 770 to a format or language for use by a user.

Turning now to FIG. 3, another example implementation in which protocol tests are generated in accordance with one or more embodiments of the protocol test generation system is shown. In this example, a series of protocol tests are generated for a DNS protocol. Features described in connection with FIG. 3, while specific to DNS protocol, may apply to implementations involving other protocols.

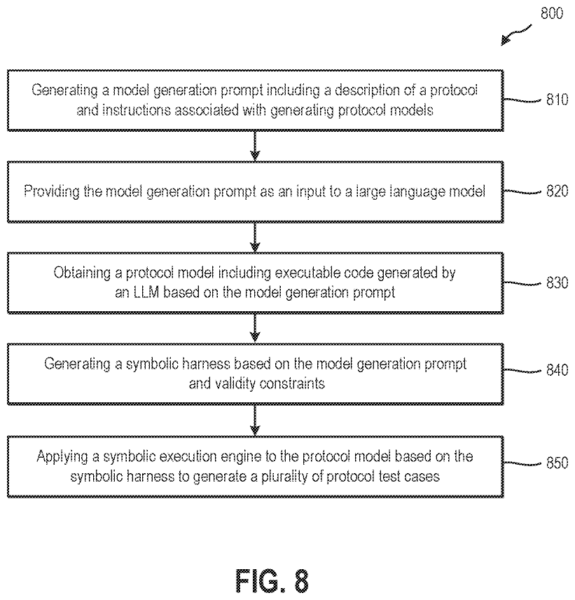

Turning now to FIG. 8, this figure illustrates example flowcharts including series of acts for generating protocol tests as described herein, according to one or more embodiments. While FIG. 8 illustrates acts according to one or more embodiments, alternative embodiments may omit, add to, reorder, and/or modify any of the acts shown in FIG. 8. The acts of FIG. 8 can be performed as part of a method. Alternatively, a non-transitory computer-readable medium can include instructions that, when executed by one or more processors, cause a computing device to perform the acts of FIG. 8. In still further embodiments, a system can perform the acts of FIG. 8.

By way of example, FIG. 8 illustrates a series of acts for testing a protocol. For example, the protocol may be one or more of a Quick UDP Internet Connections (QUIC) protocol, Domain Name System (DNS) protocol, or Border Gateway Patrol (BGP) protocol. The series of acts includes an act 810 of generating a model generation prompt including a description of a protocol and instructions associated with generating protocol models. For example, the model generation prompt may include definitions and functions arguments of the protocol. In some embodiments, the model generation prompt includes a library that provides restrictions on the type of input that the model is configured to receive and the type of output that the model is configured to output. In some embodiments, the model generation prompt includes a completion prompt that frames an implementation task as a completion problem. In some embodiments, the model generation prompt includes a system pro pt that guides the behavior of the LLM in generating the modeled component of the protocol.

In some embodiments, the method 800 includes an act 820 of providing the model generation prompt as an input to a large language model (LLM). As further shown, FIG. 8 illustrates an act 830 of obtaining a protocol model including executable code generated by an LLM based on the model generation prompt provided as input to the LLM. In some embodiments, the modeled component of the protocol includes a subset of protocol behaviors of the protocol.

As further shown, FIG. 8 illustrates an act 840 of generating a symbolic harness based on the model generation prompt and based on one or more validity constraints associated with inputs to be handled by the modeled component output by the LLM. The symbolic harness may be a type-specific symbolic harness in C-code in which symbolic inputs are generated for the modeled component of the protocol.

In some embodiments, the method 800 additionally includes an act 850 of applying a symbolic execution engine to the modeled component of the protocol based on the symbolic harness to generate a plurality of protocol tests associated with the modeled component of the protocol and which satisfy the one or more validity constraints of the symbolic harness. In some embodiments, the plurality of tests include an exhaustive set of test cases that follow a plurality of paths through the modeled component of the protocol based on information contained within the symbolic harness. In some embodiments, the modeled component is executable C-code based on input and output definitions and descriptions included within the model generation prompt.

In some embodiments, the method 800 includes executing the plurality of tests using a plurality of protocol implementations to determine one or more of the protocol implementations having protocol-specific issues.

The method 800 may additionally include any of the features and functionalities described above in connection with components of the protocol test generation system. In addition, the series of acts may include acts as recited below in the appending listing of claims.

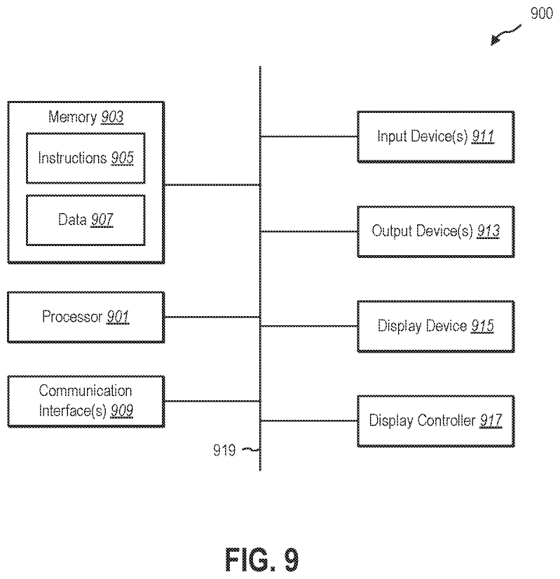

FIG. 9 illustrates certain components that may be included within a computer system 900. One or more computer systems 900 may be used to implement the various devices, components, and systems described herein.

The computer system 900 includes a processor 901. The processor 901 may be a general-purpose single- or multi-chip microprocessor (e.g., an Advanced RISC (Reduced Instruction Set Computer) Machine (ARM)), a special-purpose microprocessor (e.g., a digital signal processor (DSP)), a microcontroller, a programmable gate array, etc. The processor 901 may be referred to as a central processing unit (CPU). Although just a single processor 901 is shown in the computer system 900 of FIG. 9, in an alternative configuration, a combination of processors (e.g., an ARM and DSP) could be used. In one or more embodiments, the computer system 900 further includes one or more graphics processing units (GPUs), which can provide processing services related to both entity classification and graph generation.

The computer system 900 also includes memory 903 in electronic communication with the processor 901. The memory 903 may be any electronic component capable of storing electronic information. For example, the memory 903 may be embodied as random access memory (RAM), read-only memory (ROM), magnetic disk storage media, optical storage media, flash memory devices in RAM, on-board memory included with the processor, erasable programmable read-only memory (EPROM), electrically erasable programmable read-only memory (EEPROM) memory, registers, and so forth, including combinations thereof.

Instructions 905 and data 907 may be stored in the memory 903. The instructions 905 may be executable by the processor 901 to implement some or all of the functionality disclosed herein. Executing the instructions 905 may involve the use of the data 907 that is stored in the memory 903. Any of the various examples of modules and components described herein may be implemented, partially or wholly, as instructions 905 stored in memory 903 and executed by the processor 901. Any of the various examples of data described herein may be among the data 907 that is stored in memory 903 and used during execution of the instructions 905 by the processor 901.

A computer system 900 may also include one or more communication interfaces 909 for communicating with other electronic devices. The communication interface(s) 909 may be based on wired communication technology, wireless communication technology, or both. Some examples of communication interfaces 909 include a Universal Serial Bus (USB), an Ethernet adapter, a wireless adapter that operates in accordance with an Institute of Electrical and Electronics Engineers (IEEE) 802.11 wireless communication protocol, a Bluetooth® wireless communication adapter, and an infrared (IR) communication port.

A computer system 900 may also include one or more input devices 911 and one or more output devices 913. Some examples of input devices 911 include a keyboard, mouse, microphone, remote control device, button, joystick, trackball, touchpad, and lightpen. Some examples of output devices 913 include a speaker and a printer. One specific type of output device that is typically included in a computer system 900 is a display device 915. Display devices 915 used with embodiments disclosed herein may utilize any suitable image projection technology, such as liquid crystal display (LCD), light-emitting diode (LED), gas plasma, electroluminescence, or the like. A display controller 917 may also be provided, for converting data 907 stored in the memory 903 into text, graphics, and/or moving images (as appropriate) shown on the display device 915.

The various components of the computer system 900 may be coupled together by one or more buses, which may include a power bus, a control signal bus, a status signal bus, a data bus, etc. For the sake of clarity, the various buses are illustrated in FIG. 9 as a bus system 919.

The techniques described herein may be implemented in hardware, software, firmware, or any combination thereof, unless specifically described as being implemented in a specific manner. Any features described as modules, components, or the like may also be implemented together in an integrated logic device or separately as discrete but interoperable logic devices. If implemented in software, the techniques may be realized at least in part by a non-transitory processor-readable storage medium comprising instructions that, when executed by at least one processor, perform one or more of the methods described herein. The instructions may be organized into routines, programs, objects, components, data structures, etc., which may perform particular tasks and/or implement particular datatypes, and which may be combined or distributed as desired in various embodiments.

The steps and/or actions of the methods described herein may be interchanged with one another without departing from the scope of the claims. In other words, unless a specific order of steps or actions is required for proper operation of the method that is being described, the order and/or use of specific steps and/or actions may be modified without departing from the scope of the claims.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. For example, any element or feature described in relation to an embodiment herein may be combinable with any element or feature of any other embodiment described herein, where compatible.

The present disclosure may be embodied in other specific forms without departing from its spirit or characteristics. The described embodiments are to be considered as illustrative and not restrictive. The scope of the disclosure is, therefore, indicated by the appended claims rather than by the foregoing description. Changes that come within the meaning and range of equivalency of the claims are to be embraced within their scope.

What is claimed is:

1. A method for generating protocol tests, the method comprising:
generating a model generation prompt including a description of a protocol and instructions associated with generating protocol models;
providing the model generation prompt as an input to a large language model (LLM);
obtaining a modeled component of the protocol, the modeled component of the protocol including executable code generated by the LLM based on the model generation prompt provided as the input to the LLM;
generating a symbolic harness based on the model generation prompt and one or more validity constraints associated with inputs to be handled by the modeled component output by the LLM; and
applying a symbolic execution engine to the modeled component of the protocol based on the symbolic harness to generate a plurality of protocol tests associated with the modeled component of the protocol and which satisfy the one or more validity constraints of the symbolic harness.

2. The method of claim 1, further comprising executing the plurality of protocol tests using a plurality of protocol implementations to determine one or more of the plurality of protocol implementations having protocol-specific issues.

3. The method of claim 1, wherein the model generation prompt includes definitions and function arguments of the protocol.

4. The method of claim 1, wherein the plurality of protocol tests includes an exhaustive set of test cases that follow a plurality of paths through the modeled component of the protocol based on information contained within the symbolic harness.

5. The method of claim 1, wherein the modeled component is executable C-code based on input and output definitions and descriptions included within the model generation prompt.

6. The method of claim 1, wherein the symbolic harness is a type-specific symbolic harness in C-code in which symbolic inputs are generated for the modeled component of the protocol.

7. The method of claim 1, wherein the model generation prompt includes a library that provides restrictions on one or more types of input that the model is configured to receive and a type of output that the modeled component of the protocol is configured to output.

8. The method of claim 1, wherein the model generation prompt includes a completion prompt that frames an implementation task as a completion problem and a system prompt that guides behavior of the LLM in generating the modeled component of the protocol.

9. The method of claim 1, wherein the modeled component of the protocol includes a subset of protocol behaviors of the protocol.

10. The method of claim 1, wherein the protocol is one or more of Quick UDP Internet Connections (QUIC) protocol, Domain Name System (DNS) protocol, or Border Gateway Patrol (BGP) protocol.

11. A system, comprising:
at least one processor;
memory in electronic communication with the at least one processor; and
instructions stored in the memory, the instructions being executable by the at least one processor to:
generate a model generation prompt including a description of a protocol and instructions associated with generating protocol models;
provide the model generation prompt as an input to a large language model (LLM);
obtain a modeled component of the protocol, the modeled component of the protocol including executable code generated by the LLM based on the model generation prompt provided as the input to the LLM;
generate a symbolic harness based on the model generation prompt and based on one or more validity constraints associated with inputs to be handled by the modeled component output by the LLM; and
apply a symbolic execution engine to the modeled component of the protocol based on the symbolic harness to generate a plurality of protocol tests associated with the modeled component of the protocol and which satisfy the one or more validity constraints of the symbolic harness.

12. The system of claim 11, further comprising executing the plurality of protocol tests using a plurality of protocol implementations to determine one or more of the plurality of protocol implementations having protocol-specific issues.

13. The system of claim 11, wherein the model generation prompt includes definitions and function arguments of the protocol.

14. The system of claim 11, wherein the plurality of protocol tests includes an exhaustive set of test cases that follow a plurality of paths through the modeled component of the protocol based on information contained within the symbolic harness.

15. The system of claim 11, wherein the modeled component is executable C-code based on input and output definitions and descriptions included within the model generation prompt.

16. A non-transitory computer readable medium storing instructions thereon that, when executed by at least one processor, cause a computing device to:
generate a model generation prompt including a description of a protocol and instructions associated with generating protocol models;
provide the model generation prompt as an input to a large language model (LLM);
obtain a modeled component of the protocol, the modeled component of the protocol including executable code generated by the LLM based on the model generation prompt provided as the input to the LLM;
generate a symbolic harness based on the model generation prompt and based on one or more validity constraints associated with inputs to be handled by the modeled component output by the LLM; and
apply a symbolic execution engine to the modeled component of the protocol based on the symbolic harness to generate a plurality of protocol tests associated with the modeled component of the protocol and which satisfy the one or more validity constraints of the symbolic harness.

17. The non-transitory computer readable medium of claim 16, wherein the symbolic harness is a type-specific symbolic harness in c-code in which symbolic inputs are generated for the modeled component of the protocol.

18. The non-transitory computer readable medium of claim 16, wherein the model generation prompt includes a library that provides restrictions on one or more type of inputs that the model is configured to receive and a type of output that the modeled component of the protocol is configured to output.

19. The non-transitory computer readable medium of claim 16, wherein the model generation prompt includes a completion prompt that frames an implementation task as a completion problem and a system prompt that guides behavior of the LLM in generating the modeled component of the protocol.

20. The non-transitory computer readable medium of claim 16, wherein the modeled component of the protocol includes a subset of protocol behaviors of the protocol.
